(19) United States
(12) Patent Application Publication
(10) Pub. No.: US 2022/0166798 A1
(43) Pub. Date: May 26, 2022

(54) AUTHENTICATION SYSTEM AND METHOD

(71) Applicant: LITE-ON TECHNOLOGY CORPORATION, TAIPEI CITY (TW)

(72) Inventor: Li-Jen HSU, TAIPEI CITY (TW)

(21) Appl. No.: 17/666,919

(22) Filed: Feb. 8, 2022

(30) Foreign Application Priority Data
Nov. 8, 2021 (TW) 110141483

(51) Int. Cl. H04L 9/40

(52) U.S. Cl. CPC H04L 63/166; H04L 63/0876

(57) ABSTRACT

An authentication system is provided in the invention. The authentication system may include a core network and user equipment (UE). The core network selects an Extensible Authentication Protocol-Tunneled Transport Layer Security (EAP-TTLS) method for security authentication according to a registration request. The UE transmits the registration request to the core network to perform the security authentication.

### CROSS REFERENCE TO RELATED APPLICATIONS

This Application claims priority of TW Patent Application No. 110141483 filed on Nov. 8, 2021, the entirety of which is incorporated by reference herein.

### BACKGROUND OF THE INVENTION

### Field of the Invention

The invention generally relates to authentication technology, and more particularly, to authentication technology in which the Extensible Authentication Protocol-Tunneled Transport Layer Security (EAP-TTLS) method is used for the security authentication between the user equipment (UE) and network end in 5G network.

### Description of the Related Art

In current 3^{rd}-Generation Partnership Project (3GPP) standard for the 5G New Radio (NR) mobile communication, a conscientious authentication process is adopted for confirming whether the user can access the network resource legally.

However, in the 3GPP standard, the Unlicensed Spectrum can be used to access 5G NR network. Therefore, when conducting security authentication between the user equipment (UE) and the network end, a more flexible and safer authentication method is needed, and hence this is a subject that is worthy of discussion.

### BRIEF SUMMARY OF THE INVENTION

An authentication system and method are provided to overcome the problems mentioned above.

An embodiment of the invention provides an authentication system. The authentication system may include a core network and user equipment (UE). The core network selects an Extensible Authentication Protocol-Tunneled Transport Layer Security (EAP-TTLS) method for security authentication according to a registration request. The UE transmits the registration request to the core network to perform the security authentication.

According to an embodiment of the invention, the core network may include a Security Anchor Function (SEAF) device, an Authentication Server Function (AUSF) device and a Unified Data Management (UDM) device. The SEAF device receives the registration request and generates an authentication request according to the registration request. The AUSF device receives the authentication request from the SEAF device. The UDM device receives the authentication request from the AUSF device and selects the EAP-TTLS method for the security authentication according to the authentication request.

According to an embodiment of the invention, the core network transmits certificate data to the UE according to the EAP-TTLS method. The UE authenticates the network end according to the certificate data. When the UE authenticates the network end successfully according to the certificate data, the UE transmits authentication data to the core network. The authentication data may comprise an account number and a password. The core network authenticates the UE according to the authentication data. When the core network authenticates the UE successfully according to the authentication data, it means that the security authentication has been successfully completed.

The core network may determine whether to adopt the EAP-TTLS method for the security authentication according to a Subscription Permanent Identifier (SUPI) in the registration request.

An embodiment of the invention provides an authentication method. The authentication method is applied to an authentication system. The authentication method may include the steps of using the user equipment (UE) of the authentication system to transmit a registration request to a core network of the authentication system to perform a security authentication; and using the core network to select an Extensible Authentication Protocol-Tunneled Transport Layer Security (EAP-TTLS) method for the security authentication according to the registration request.

Other aspects and features of the invention will become apparent to those with ordinary skill in the art upon review of the following descriptions of specific embodiments of an authentication system and method.

### BRIEF DESCRIPTION OF THE DRAWINGS

The invention will become more fully understood by referring to the following detailed description with reference to the accompanying drawings, wherein:

FIG. 1 is a block diagram of user equipment (UE) 110 according to an embodiment of the invention;

FIG. 2 is a schematic diagram illustrating an authentication system 200 according to an embodiment of the invention;

FIGS. 3A-3B is a flow chart illustrating the authentication method according to an embodiment of the invention; and

FIG. 4 is a flow chart illustrating the authentication method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

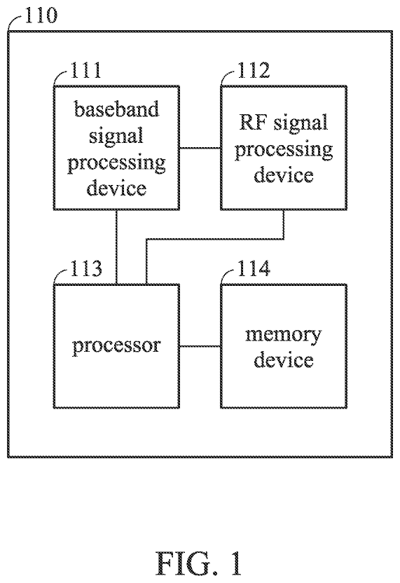

FIG. 1 is a block diagram of user equipment (UE) 110 according to an embodiment of the invention. As shown in FIG. 1, the UE 110 may comprise at least a baseband signal processing device 111, a radio frequency (RF) signal processing device 112, a processor 113, a memory device 114, and an antenna module comprising at least one antenna. It should be noted that in order to clarify the concept of the invention, FIG. 1 presents a simplified block diagram in which only the elements relevant to the invention are shown. However, the invention should not be limited to what is shown in FIG. 1.

In the embodiments of the invention, the UE 110 may be a smartphone, Personal Data Assistant (PDA), pager, laptop computer, desktop computer, wireless handset, or any computing device that includes a wireless communications interface.

The RF signal processing device 112 may receive RF signals via the antenna and process the received RF signals to convert the received RF signals to baseband signals to be processed by the baseband signal processing device 111, or receive baseband signals from the baseband signal processing device 111 and convert the received baseband signals to RF signals to be transmitted to a peer communications apparatus. The RF signal processing device 112 may comprise a plurality of hardware elements to perform radio frequency conversion. For example, the RF signal processing device 112 may comprise a power amplifier, a mixer, analog-to-digital converter (ADC)/digital-to-analog converter (DAC), etc.

The baseband signal processing device 111 may further process the baseband signals to obtain information or data transmitted by the peer communications apparatus. The baseband signal processing device 111 may also comprise a plurality of hardware elements to perform baseband signal processing.

The processor 113 may control the operations of the baseband signal processing device 111 and the RF signal processing device 112. According to an embodiment of the invention, the processor 113 may also be arranged to execute the program codes of software modules of the corresponding baseband signal processing device 111 and/or the RF signal processing device 112. The program codes accompanied by specific data in a data structure may also be referred to as a processor logic unit or a stack instance when being executed. Therefore, the processor 113 may be regarded as being comprised of a plurality of processor logic units, each for executing one or more specific functions or tasks of corresponding software modules.

The memory device 114 may store the software and firmware program codes, system data, user data, etc. of the UE 110. The memory device 114 may be a volatile memory such as a Random Access Memory (RAM); a non-volatile memory such as a flash memory or Read-Only Memory (ROM); a hard disk; or any combination thereof.

According to an embodiment of the invention, the RF signal processing device 112 and the baseband signal processing device 111 may collectively be regarded as a radio module capable of communicating with a wireless network to provide wireless communications services in compliance with a predetermined Radio Access Technology (RAT). Note that, in some embodiments of the invention, the UE 110 may be extended further to comprise more than one antenna and/or more than one radio module, and the invention should not be limited to what is shown in FIG. 1.

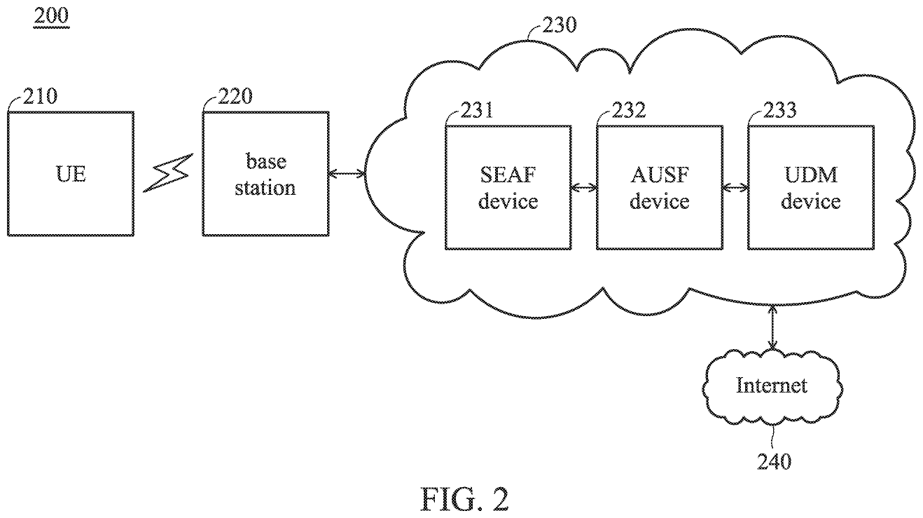

FIG. 2 is a schematic diagram illustrating an authentication system 200 according to an embodiment of the invention. As shown in FIG.2, the authentication system 200 may comprise user equipment (UE) 210, a base station 220 (e.g. a gNB), a 5G core network 230 and an internet (or data network) 240. In addition, as shown in FIG. 2, the 5G core network 230 may comprise a Security Anchor Function (SEAF) device 231, an Authentication Server Function (AUSF) device 232 and a Unified Data Management (UDM) device 233. It should be noted that the schematic diagram of FIG. 2 may be only used to illustrate the embodiments of the invention, but the invention should not be limited thereto. The 5G core network may also comprise other devices and elements. In addition, the UE 110 of FIG. 1 may be applied to the UE 210. In addition, it should be noted that in the invention, the 5G core network is used for illustration, but the invention should not be limited thereto. Any core network which has similar structures as 5G core network can also be applied to the invention.

According to an embodiment of the invention, when a security authentication between the UE 210 and network end needs to be performed, the 5G core network 230 may adapt an Extensible Authentication Protocol-Tunneled Transport Layer Security (EAP-TTLS) method to perform the security authentication. Details are illustrated below.

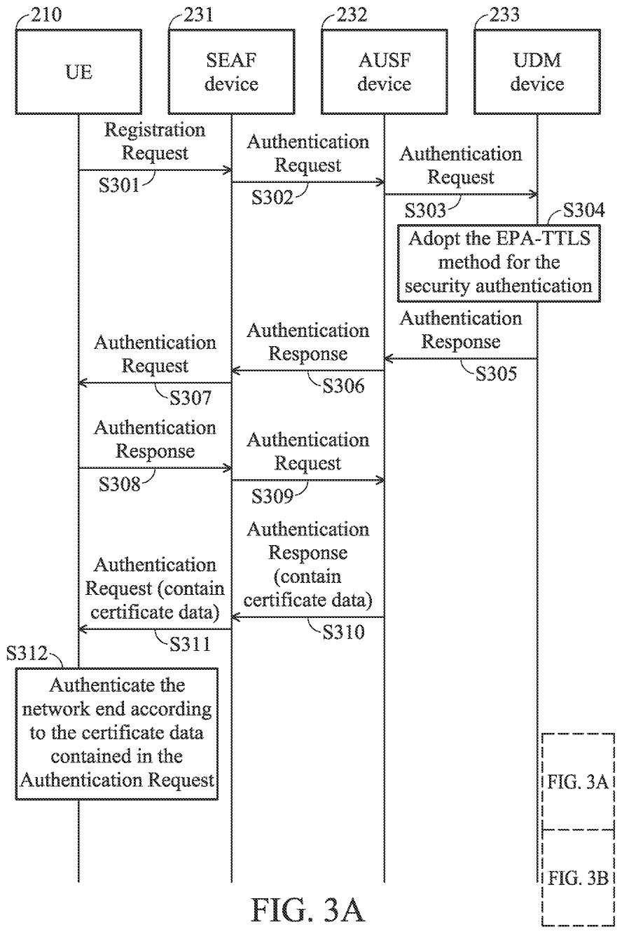

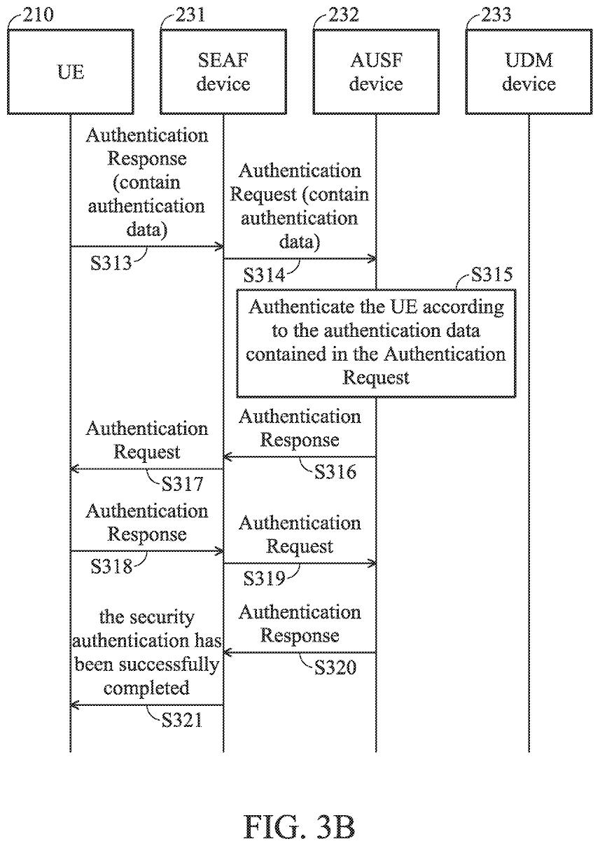

FIGS. 3A-3B is a flow chart illustrating the authentication method according to an embodiment of the invention. FIG. 2 is taken with FIGS. 3A-3B for illustration below.

In step S301, when the security authentication between the UE 210 and network end needs to be performed, the SEAF device 231 of the 5G core network 230 may receive a Registration Request from the UE 210 through the base station 220. According to an embodiment of the invention, the Registration Request may comprise a Subscription Concealed Identifier (SUCI) corresponding to the UE 210.

In step S302, the SEAF device 231 of the 5G core network 230 may generate an Authentication Request according to the Registration Request, and transmit the Authentication Request to the AUSF device 232. According to an embodiment of the invention, the Authentication Request of step S302 may comprise the SUCI and a serving network name (SN-name) corresponding to the UE 210.

In step S303, the AUSF device 232 may transmit an Authentication Request to the UDM device 233 according to the Authentication Request from the SEAF device 231. According to an embodiment of the invention, the Authentication Request of step S303 may comprise the SUCI and the SN-name corresponding to the UE 210.

In step S304, according to the Authentication Request, the UDM device 233 may determine whether to adopt the EPA-TTLS method for the security authentication. Specifically, the UDM device 233 may use the Subscription Identifier De-concealing Function (SIDF) to decode the SUCI corresponding to the UE 210 in the Authentication Request to obtain the Subscription Permanent Identifier (SUPI) corresponding to the UE 210. Then, according to the SUPI corresponding to the UE 210, the UDM device 233 may determine whether to adopt the EPA-TTLS method for the following steps of the security authentication. According to an embodiment of the invention, if according to the SUPI corresponding to the UE 210, the UDM device 233 determines that the EPA-TTLS method cannot be adopted for the following steps of the security authentication, the UDM device 233 may select other current methods for the security authentication, e.g. the methods adopted in 3GPP TS 33.501 standard, e.g. Extensible Authentication Protocol-Authentication an Key Agreement′ (EAP-AKA′), 5G-AKA and Extensible Authentication Protocol-Transport Layer Security (EAP-TLS). As shown in FIG. 3A, the UDM device 233 may adopt the EAP-TTLS method for the following steps of the security authentication. According to an embodiment of the invention, it may be pre-set in the UDM device 233 that the EAP-TTLS method is adopted for security authentication when the UE does not install an universal subscriber identity module (USIM).

In step S305, the UDM device 233 may transmit an Authentication Response to the AUSF device 232. According to an embodiment of the invention, the Authentication Response in step S305 may comprise the SUPI corresponding to the UE 210 and an identifier which indicates that the EAP-TTLS method is adopted.

In step S306, according to the Authentication Response from the UDM device 233, the AUSF device 232 may select the EAP-TTLS method as the authentication method and transmit an Authentication Response to the SEAF device 231. According to an embodiment of the invention, the Authentication Response in step S306 may comprise information of the EAP-type (i.e. EAP-type=EAP-TTLS (TTLS Start)).

In step S307, after the SEAF device 231 receives the Authentication Response from the AUSF device 232, the SEAF device 231 may transmit an Authentication Request to the UE 210. According to an embodiment of the invention, the Authentication Request in step S307 may comprise information of the EAP-type (i.e. EAP-type=EAP-TTLS (TTLS Start)) and the parameters of the Key Set Identifier for Next Generation Radio Access Network (ngKSI) and the Anti-Bidding down Between Architecture (ABBA).

In step S308, after the UE 210 receives the Authentication Request from the SEAF device 231, the UE 210 may respond by sending an Authentication Response to the SEAF device 231. According to an embodiment of the invention, the Authentication Response in step S308 may comprise information of the EAP-type (i.e. EAP-type=EAP-TTLS (TTLS client hello)).

In step S309, after the SEAF device 231 receives the Authentication Response from the UE 210, the SEAF device 231 may transmit an Authentication Request to the AUSF device 232. According to an embodiment of the invention, the Authentication Request in step S309 may comprise information of the EAP-type (i.e. EAP-type=EAP-TTLS (TTLS client hello)).

In step S310, after the AUSF device 232 receives the Authentication Request from the SEAF device 231, the AUSF device 232 may transmit an Authentication Response to the SEAF device 231. According to an embodiment of the invention, the Authentication Response in step S310 may comprise information of the EAP-type (i.e. EAP-type=EAP-TTLS) and certificate data, wherein the certificate data may comprise information such as server hello, server certificate, server key exchane, certificate request and server hellodone.

In step S311, after the SEAF device 231 receives the Authentication Response from the AUSF device 232, the SEAF device 231 may transmit an Authentication Request to the UE 210. According to an embodiment of the invention, the Authentication Request in step 311 may comprise information of the EAP-type (i.e. EAP-type=EAP-TTLS), certificate data, and the parameters of ngKSI and ABBA, wherein the certificate data may comprise information such as server_hello, server_certificate, server_key_exchane, certificate_request and server_hellodone.

In step S312, after the UE 210 receives the Authentication Request from the SEAF device 231, the UE 210 may authenticate the network end according to information contained in the Authentication Request. When the UE 210 cannot authenticate the network end according to the information in the Authentication Request, it means that the security authentication between the UE 210 and the network end fails.

In step S313, when the UE 210 successfully authenticates the network end according to information in the Authentication Request, the UE 210 may respond by sending an Authentication Response to the SEAF device 231. According to an embodiment of the invention, the Authentication Response in step S313 may comprise information of the EAP-type (i.e. EAP-type=EAP-TTLS) and authentication data. According to an embodiment of the invention, the authentication data may comprise an account number and a password. It should be noted that in the embodiment, the EAP-TTLS method is adopted for the security authentication between the UE 210 and the network end. Therefore, comparing to the EAP-TLS method, the certificate will not need to be installed in the UE 210. That is to say, the UE 210 only needs to provide the authentication data (e.g. account number and password) to the network end for the security authentication without providing certificate data to the network end. In addition, comparing to the EAP-AKA′ method and 5G-AKA method which are performed based on the Subscribe Identity Module (SIM), the EAP-TTLS method can be performed for authentication without the SIM.

In step S314, after the SEAF device 231 receives the Authentication Response from the UE 210, the SEAF device 231 may transmit an Authentication Request to the AUSF device 232. According to an embodiment of the invention, the Authentication Request in step S314 may comprise information of the EAP-type (i.e. EAP-type=EAP-TTLS) and the authentication data provided by the UE 210.

In step S315, after the AUSF device 232 receives the Authentication Request from the SEAF device 231, the AUSF device 232 may perform the authentication to the UE 210 according to the information (i.e. the authentication data provided by the UE 210) in the Authentication Request. When the AUSF device 232 cannot authenticate the UE 210 successfully according to the information in the Authentication Request, it means that the security authentication between the UE 210 and the network end fails.

In step S316, when the AUSF device 232 authenticates the UE 210 successfully according to the information in the Authentication Request, the AUSF device 232 may transmit an Authentication Response to the SEAF device 231. According to an embodiment of the invention, the Authentication Response in step S316 may comprise information of the EAP-type (i.e. EAP-type=EAP-TTLS) and information such as change_cipher_spec and server_finished.

In step S317, after the SEAF device 231 receives the Authentication Response from the AUSF device 232, the SEAF device 231 may transmit an Authentication Request to the UE 210. According to an embodiment of the invention, the Authentication Request in step S317 may comprise information of the EAP-type (i.e. EAP-type=EAP-TTLS), information such as change_cipher_spec and server_finished, and the parameters of ngKSI and ABBA.

In step S318, after the UE 210 receives the Authentication Request from the SEAF device 231, the UE 210 may respond by sending an Authentication Response to the SEAF device 231. According to an embodiment of the invention, the Authentication Response in step S318 may only comprise information of the EAP-type (i.e. EAP-type=EAP-TTLS).

In step S319, after the SEAF device 231 receives the Authentication Response from the UE 210, the SEAF device 231 may transmit an Authentication Request to the AUSF device 232. According to an embodiment of the invention, the Authentication Request in step S319 may only comprise information of the EAP-type (i.e. EAP-type=EAP-TTLS).

In step S320, after the AUSF device 232 receives the Authentication Request from the SEAF device 231, the AUSF device 232 may transmit an Authentication Response to the SEAF device 231. The Authentication Response in step S320 may comprise the information of EAP success, an anchor key and the SUPI corresponding to the UE 210.

In step S321, after the SEAF device 231 receives the Authentication Response from the AUSF device 232, the SEAF device 231 may transmit the information of EAP success and the parameters of ngKSI and ABBA to the UE 210. It means that the security authentication between the UE 210 and the network end has been successfully completed.

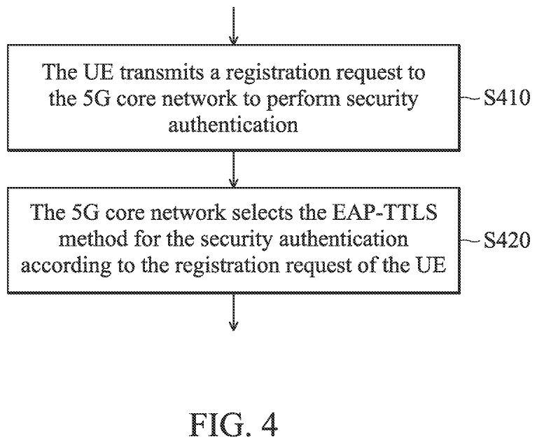

FIG. 4 is a flow chart illustrating an authentication method according to an embodiment of the invention. The authentication method can be applied to the authentication system 200. As shown in FIG. 4, in step S410, the UE of the authentication system 200 may transmit a registration request to the 5G core network of the authentication system 200 to perform a security authentication.

In step S420, the 5G core network of the authentication system 200 selects the EAP-TTLS method for the security authentication according to the registration request of the UE.

According to the embodiments of the invention, the step S410 may further comprise that a Security Anchor Function (SEAF) device of the 5G core network of the authentication system 200 may receive the registration request and generate an authentication request according to the registration request. The step S420 may further comprise that an Authentication Server Function (AUSF) device of the 5G core network of the authentication system 200 may receive the authentication request from the SEAF device and a Unified Data Management (UDM) device 233 of the 5G core network of the authentication system 200 may receive the authentication request from the AUSF device and select the EAP-TTLS method for the security authentication according to the authentication request.

According to the embodiments of the invention, in the authentication method, the 5G core network of the authentication system 200 may transmit certificate data to the UE of the authentication system 200 according to the EAP-TTLS method. The UE may use the certificate data to authenticate the network end. When the UE cannot authenticate the network end successfully according to the certificate data, it means that the security authentication between the UE and the network end fails. When the UE can authenticate the network end successfully according to the certificate data, the UE may transmit authentication data to the 5G core network. According to an embodiment of the invention, the authentication data may comprise an account number and a password. The 5G core network may authenticate the UE according to the authentication data. When the 5G core network cannot authenticate the UE successfully according to the authentication data, it means that the security authentication between the UE and the network end fails. When the 5G core network can authenticate the UE successfully according to the authentication data, it means that the security authentication between the UE and the network end has been successfully completed.

According to the embodiments of the invention, in step S420 of the authentication method, the 5G core network may determine whether to adopt the EAP-TTLS method for the security authentication according to a Subscription Permanent Identifier (SUPI) in the registration request. If the 5G core network determines that the EPA-TTLS method cannot be adopted for the following steps of the security authentication, the 5G core network may select other current methods for the security authentication, e.g. the methods adopted in 3GPP TS 33.501 standard, e.g. Extensible Authentication Protocol-Authentication an Key Agreement′ (EAP-AKA′), 5G-AKA and Extensible Authentication Protocol-Transport Layer Security (EAP-TLS).

According to the authentication method provided in the invention, the EAP-TTLS method can be applied for the security authentication between the UE and the network end. Therefore, according to the authentication method provided in the invention, in the 5G NR communication, in the procedure of the security authentication between the UE and the network end, a more convenient and flexible method can be adopted for the security authentication between the UE and the network end.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An authentication system, comprising:
a core network, selecting an Extensible Authentication Protocol-Tunneled Transport Layer Security (EAP-TTLS) method for a security authentication according to a registration request; and
a user equipment (UE), transmitting the registration request to the core network to perform the security authentication.

2. The authentication system of claim 1, wherein the core network comprises:
a Security Anchor Function (SEAF) device, receiving the registration request and generating an authentication request according to the registration request;
an Authentication Server Function (AUSF) device, receiving the authentication request from the SEAF device; and
a Unified Data Management (UDM) device, receiving the authentication request from the AUSF device and selecting the EAP-TTLS method for the security authentication according to the authentication request.

3. The authentication system of claim 1, wherein the core network transmits a certificate data to the UE according to the EAP-TTLS method.

4. The authentication system of claim 3, wherein the UE authenticates the network end according to the certificate data.

5. The authentication system of claim 4, wherein when the UE authenticates the network end successfully according to the certificate data, the UE transmits an authentication data to the core network.

6. The authentication system of claim 5, wherein the authentication data comprises an account number and a password.

7. The authentication system of claim 5, wherein the core network authenticates the UE according to the authentication data.

8. The authentication system of claim 7, wherein when the core network authenticates the UE successfully according to the authentication data, it means that the security authentication has been successfully completed.

9. The authentication system of claim 1, wherein the core network determines whether to adopt the EAP-TTLS method for the security authentication according to a Subscription Permanent Identifier (SUPI) in the registration request.

10. An authentication method, applied to an authentication system, comprising:
transmitting, by a user equipment (UE) of the authentication system, a registration request to a core network of the authentication system to perform a security authentication; and
selecting, by the core network, an Extensible Authentication Protocol-Tunneled Transport Layer Security (EAP-TTLS) method for the security authentication according to the registration request.

11. The authentication method of claim 10, further comprising:
receiving, by a Security Anchor Function (SEAF) device of the core network, the registration request and generating an authentication request according to the registration request;
receiving, by an Authentication Server Function (AUSF) device of the core network, the authentication request from the SEAF device; and
receiving, by a Unified Data Management (UDM) device of the core network, the authentication request from the AUSF device and selecting the EAP-TTLS method for the security authentication according to the authentication request.

12. The authentication method of claim 10, wherein the core network transmits a certificate data to the UE according to the EAP-TTLS method.

13. The authentication method of claim 12, further comprising:
authenticating, by the UE, the network end according to the certificate data.

14. The authentication method of claim 13, further comprising:
when the UE successfully authenticates the network end according to the certificate data, transmitting, by the UE, an authentication data to the core network.

15. The authentication method of claim 14, wherein the authentication data comprises an account number and a password.

16. The authentication method of claim 14, further comprising:
authenticating, by the core network, the UE according to the authentication data.

17. The authentication method of claim 16, further comprising:
when the core network successfully authenticates the UE according to the authentication data, it means that the security authentication has been successfully completed.

18. The authentication method of claim 10, further comprising:
determining, by the core network, whether to adopt the EAP-TTLS method for the security authentication according to a Subscription Permanent Identifier (SUPI) in the registration request.
